(19) United States
(12) Patent Application Publication
(10) Pub. No.: US 2025/0285452 A1
(43) Pub. Date: Sep. 11, 2025

(54) DETERMINATION DEVICE, DETERMINATION METHOD, AND STORAGE MEDIUM

(71) Applicant: HONDA MOTOR CO., LTD., Tokyo (JP)

(72) Inventor: Daichi Inoue, Tokyo (JP)

(21) Appl. No.: 19/059,614

(22) Filed: Feb. 21, 2025

(30) Foreign Application Priority Data
Mar. 8, 2024 (JP) 2024-035554

(51) Int. Cl. G06V 20/56

(52) U.S. Cl. CPC G06V 20/588

(57) ABSTRACT

A determination device of an embodiment includes a first recognizer configured to recognize surrounding conditions including a first dividing line defining a traveling lane of a host vehicle and another vehicle present around the host vehicle based on an output of a detection device, a second recognizer configured to recognize a second dividing line defining a lane around the host vehicle from map, and a determiner configured to perform a correctness determination as to whether or not at least one of the first and the second dividing line is correct, in which when a first other vehicle that performs a lateral movement ahead of the host vehicle and a second other vehicle that doesn't perform a lateral movement ahead of the first other vehicle are present among a plurality of other vehicles recognized, the determiner doesn't perform the correctness determination based on a traveling path of the first other vehicle.

### CROSS-REFERENCE TO RELATED APPLICATION

Priority is claimed on Japanese Patent Application No. 2024-035554, filed Mar. 8, 2024, the content of which is incorporated herein by reference.

### BACKGROUND

### Field of the Invention

The present invention relates to a determination device, a determination method, and a storage medium.

### Description of Related Art

In recent years, efforts to provide access to sustainable transportation systems that take into consideration vulnerable people among traffic participants have been actively made. To achieve this, the focus is on research and development to further improve traffic safety and convenience through research and development of automated driving technology. In this regard, a technology for controlling a driving actuator on the basis of a first sensor that images or measures dividing lines in a traveling direction of a vehicle, a second sensor that detects movement of a forward vehicle, position information of the dividing lines obtained by the first sensor, and a degree of reliability of the position information is known in the related art (for example, Japanese Unexamined Patent Application, First Publication No. 2022-39469).

### SUMMARY

However, the automated driving technology in the related art has a problem in that, in the case of determining the correctness as to whether or not the dividing lines are correct using the recognized dividing lines and traveling paths of other vehicles, if some of other vehicles among a plurality of other vehicles are changing lanes, it may not be possible to properly perform the correctness determination as to whether or not the dividing lines are correct.

In order to solve the above problem, one of objects of the present application is to provide a determination device, a determination method, and a storage medium in which correctness of dividing lines can be more appropriately determined in accordance with the dividing lines around a host vehicle and a state of another vehicle. In addition, this will ultimately contribute to development of a sustainable transportation system.

The determination device, the determination method, and the storage medium according to the present invention adopt the following configurations.
(1) A determination device according to one aspect of the present invention includes: a first recognizer configured to recognize surrounding conditions including a first dividing line defining a traveling lane of a host vehicle and another vehicle present around the host vehicle on the basis of an output of a detection device configured to detect surrounding conditions of the host vehicle; a second recognizer configured to recognize a second dividing line defining a lane around the host vehicle from map information on the basis of position information of the host vehicle; and a determiner configured to perform a correctness determination as to whether or not at least one of the first dividing line and the second dividing line is correct on the basis of at least one of the first dividing line and the second dividing line and a traveling path of the other vehicle, wherein when a first other vehicle that is performing a lateral movement ahead of the host vehicle and a second other vehicle that is not performing a lateral movement ahead of the first other vehicle are present among a plurality of other vehicles recognized by the first recognizer, the determiner does not perform the correctness determination based on a traveling path of the first other vehicle.
(2) In the above aspect (1), when the second other vehicle is at the same position as a lateral position of the first other vehicle reached as a result of the lateral movement or present there before the lateral movement and is ahead of the first other vehicle, the determiner does not perform the correctness determination based on the traveling path of the first other vehicle.
(3) In the above aspect (1), the determiner determines that, among the first dividing line and the second dividing line, a dividing line along a traveling path of the second other vehicle is a correct dividing line.
(4) In the above aspect (1), the determiner determines that, among the first dividing line and the second dividing line, a dividing line whose discrepancy angle with respect to a traveling direction of the second other vehicle is equal to or smaller than a threshold is a correct dividing line.
(5) In the above aspect (2), when a third other vehicle whose lateral position reached as a result of a lateral movement or a lateral position before the lateral movement is different from a lateral position of the second other vehicle is present behind the second other vehicle, the determiner does not perform the correctness determination based on the traveling path of the first other vehicle and a traveling path of the third other vehicle.
(6) In the above aspect (5), the third other vehicle is a vehicle whose lateral position reached as a result of the lateral movement or the lateral position before the lateral movement is at the lateral position of the first other vehicle before the lateral movement of the first other vehicle.
(7) In the above aspect (5), the third other vehicle is a vehicle that performs the lateral movement in the same direction as the first other vehicle.
(8) In the above aspect (1), the determiner performs the correctness determination in a region of a predetermined width in a vehicle width direction on the basis of a position at which the second other vehicle is present.
(9) In the above aspect (1), when only a traveling path in which the traveling path of the second other vehicle is farther away than a point at which the lateral movement of the first other vehicle that performs the lateral movement is completed ahead of the host vehicle is acquired, the determiner performs the correctness determination based on the traveling path of the first other vehicle and the traveling path of the second other vehicle.
(10) A determination method according to one aspect of the present invention is configured to cause a computer to execute: recognizing surrounding conditions including a first dividing line defining a traveling lane of a host vehicle and another vehicle present around the host vehicle on the basis of an output of a detection device configured to detect surrounding conditions of the host vehicle; recognizing a second dividing line defining a lane around the host vehicle from map information on the basis of position information of the host vehicle; and performing a correctness determination as to whether or not at least one of the first dividing line and the second dividing line is correct on the basis of at least one of the first dividing line and the second dividing line and a traveling path of the other vehicle, wherein when a first other vehicle that performs a lateral movement ahead of the host vehicle and a second other vehicle that does not perform a lateral movement ahead of the first other vehicle are present among a plurality of other vehicles recognized, the correctness determination based on a traveling path of the first other vehicle is not performed.
(11) A storage medium according to one aspect of the present invention is a computer-readable non-transitory storage medium that stores a program configured to cause a computer to execute: recognizing surrounding conditions including a first dividing line that divides a traveling lane of a host vehicle and another vehicle present around the host vehicle on the basis of an output of a detection device that detects surrounding conditions of the host vehicle; recognizing a second dividing line that divides a lane around the host vehicle from map information on the basis of position information of the host vehicle; and performing a correctness determination as to whether or not at least one of the first dividing line and the second dividing line is correct on the basis of at least one of the first dividing line and the second dividing line and a traveling path of the other vehicle, wherein when a first other vehicle that performs a lateral movement ahead of the host vehicle and a second other vehicle that does not perform a lateral movement ahead of the first other vehicle are present among a plurality of other recognized vehicles, the correctness determination based on a traveling path of the first other vehicle is not performed.

According to the above aspects (1) to (11), correctness of the dividing lines can be more appropriately determined in accordance with the dividing lines around the host vehicle and the states of other vehicles.

### BRIEF DESCRIPTION OF THE DRAWINGS

FIG. 1 is a configuration diagram of a vehicle system including a vehicle control device according to an embodiment.

FIG. 2 is a functional configuration diagram of a first controller and a second controller.

FIG. 3 is a diagram for illustrating determination processing for a host vehicle in a first scene.

FIG. 4 is a diagram for illustrating the determination processing for the host vehicle in a second scene.

FIG. 5 is a diagram for illustrating the determination processing for the host vehicle in a third scene.

FIG. 6 is a diagram for illustrating the determination processing for the host vehicle in a fourth scene.

FIG. 7 is a flowchart showing an example of processing executed by an automated driving control device according to an embodiment.

### DESCRIPTION OF EMBODIMENTS

A determination device, a determination method, and a storage medium according to the present invention will be described below with reference to the drawings. In the following, as an example, an embodiment will be described in which a vehicle control device including the determination device that performs a correctness determination as to whether or not a road dividing line (or a lane) that divides a lane on which a vehicle travels is a correct dividing line (or lane) is applied to an automated driving vehicle. Automated driving indicates, for example, automatically controlling one or both of steering and a speed of a vehicle to perform driving control. The above-described driving control may include, for example, an adaptive cruise control system (ACC), a traffic jam pilot (TJP), a lane keeping assistance system (LKAS), an automated lane change (ALC), a collision mitigation brake system (CMBS), or the like. For an automated driving vehicle, driving control may be performed by a manual operation of a user (for example, an occupant) of a vehicle (so-called manual driving). In the following, a case will be described in which the law for driving on the left side is applied, but if the law for driving on the right side is applied, the left and right may be read in reverse.

### Overall Configuration

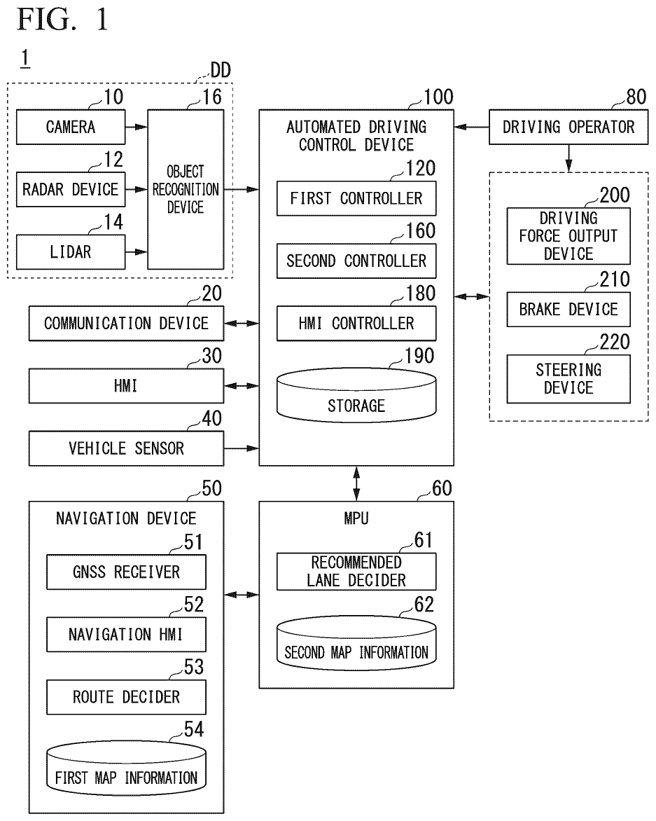

FIG. 1 is a configuration diagram of a vehicle system 1 including a vehicle control device according to an embodiment. A vehicle in which the vehicle system 1 is mounted (hereinafter referred to as a host vehicle M) may be, for example, a two-wheeled, three-wheeled, or four-wheeled vehicle, and its drive source may be an internal combustion engine such as a diesel engine or a gasoline engine, an electric motor, or a combination of these. An electric motor operates using electric power generated by a generator connected to an internal combustion engine, or discharged power from a battery (storage battery) such as a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, an automated driving control device 100, a driving force output device 200, a brake device 210, and a steering device 220. These devices and apparatuses are connected to each other via multiple communication lines such as a controller area network (CAN) communication line, serial communication lines, wireless communication networks, or the like. The configuration shown in FIG. 1 is merely an example, and some of the configuration may be omitted, or other configurations may be further added. A combination of the camera 10, the radar device 12, the LIDAR 14, and the object recognition device 16 is an example of a “detection device DD.” The HMI 30 is an example of an “output device.” The automated driving control device 100 is an example of a “vehicle control device.”

The camera 10 is, for example, a digital camera using a solid-state image sensor such as a charge coupled device (CCD) or a complementary metal oxide semiconductor (CMOS). The camera 10 is attached to any location on the host vehicle M in which the vehicle system 1 is mounted. In the case of imaging the front, the camera 10 is attached to an upper portion of a front windshield, a rear surface of a room mirror, a front head portion of a vehicle body, or the like. In the case of imaging the rear, the camera 10 is attached to an upper portion of a rear windshield, a back door, or the like. In the case of the side, the camera 10 is attached to a door mirror, or the like. The camera 10 periodically and repeatedly images surroundings of the host vehicle M. The camera 10 may be a stereo camera.

The radar device 12 emits radio waves such as millimeter waves around the host vehicle M and detects radio waves reflected by an object therearound (reflected waves) to detect at least a position (a distance and a direction) of the object. The radar device 12 is attached to any location on the host vehicle M. The radar device 12 may detect a position and a speed of the object using a frequency modulated continuous wave (FM-CW) method.

The LIDAR 14 radiates light around the host vehicle M and measures scattered light therefrom. The LIDAR 14 detects a distance to a target on the basis of a time between light emission and light reception. The radiated light is, for example, pulsed laser light. The LIDAR 14 is attached to any location on the host vehicle M.

The object recognition device 16 performs sensor fusion processing on detection results from some or all of the camera 10, the radar device 12, and the LIDAR 14 and recognizes a position, a type, a speed, or the like of the object. The object recognition device 16 outputs the recognition results to the automated driving control device 100. The object recognition device 16 may output the detection results from the camera 10, the radar device 12, and the LIDAR 14 directly to the automated driving control device 100. In that case, the object recognition device 16 may be omitted from the configuration of the vehicle system 1 (detection device DD).

The communication device 20 uses, for example, a network such as a cellular network, a Wi-Fi network, Bluetooth (registered trademark), dedicated short range communication (DSRC), a local area network (LAN), a wide area network (WAN), or the Internet to communicate with, for example, other vehicles present around the host vehicle M, a terminal device of a user using the host vehicle M, or various server devices.

The HMI 30 outputs various types of information to an occupant of the host vehicle M and receives an input operation performed by the occupant. The HMI 30 includes, for example, various display devices, speakers, buzzers, touch panels, switches, keys, microphones, or the like.

The vehicle sensor 40 includes a vehicle speed sensor for detecting a speed of the host vehicle M, an acceleration sensor for detecting an acceleration, a yaw rate sensor for detecting a yaw rate (for example, a rotational angular velocity around a vertical axis passing through a center of gravity point of the host vehicle M), and a direction sensor for detecting an orientation of the host vehicle M. The vehicle sensor 40 may be provided with a position sensor for detecting a position of the vehicle. The position sensor is an example of a “position measurer.” The position sensor is, for example, a sensor for acquiring position information (longitude and latitude information) from a Global Positioning System (GPS) device. The position sensor may be a sensor for acquiring the position information using a Global Navigation Satellite System (GNSS) receiver 51 of the navigation device 50. The vehicle sensor 40 may derive the speed of the host vehicle M from a difference (that is, a distance) in the position information at a predetermined time in the position sensor. The results detected by the vehicle sensor 40 are output to the automated driving control device 100.

The navigation device 50 includes, for example, the GNSS receiver 51, a navigation HMI 52, and a route decider 53. The navigation device 50 stores first map information 54 in a storage device such as a hard disk drive (HDD) or a flash memory. The GNSS receiver 51 identifies a position of the host vehicle M on the basis of signals received from a GNSS satellite. The position of the host vehicle M may be identified or supplemented by an inertial navigation system (INS) that uses the output of the vehicle sensor 40. The navigation HMI 52 includes a display device, a speaker, a touch panel, keys, or the like. The GNSS receiver 51 may be provided in the vehicle sensor 40. The navigation HMI 52 may be partially or entirely shared with the above-described HMI 30. The route decider 53 decides, for example, a route (hereinafter, a route on a map) from a position of the host vehicle M specified by the GNSS receiver 51 (or any input position) to a destination input by the occupant using the navigation HMI 52 with reference to the first map information 54. The first map information 54 is, for example, information in which road shapes are expressed by links indicating roads and nodes connected by the links. The first map information 54 may include point of interest (POI) information, or the like. The route on the map is output to the MPU 60. The navigation device 50 may perform route guidance using the navigation HMI 52 on the basis of the route on the map. The navigation device 50 may transmit the current position and the destination to a navigation server via the communication device 20 and acquire a route equivalent to the route on the map from the navigation server. The navigation device 50 outputs the decided route on the map to the MPU 60.

The MPU 60 includes, for example, a recommended lane decider 61, and stores second map information 62 in a storage device such as an HDD or a flash memory. The recommended lane decider 61 divides the route on the map provided by the navigation device 50 into a number of blocks (for example, every 100 m in a traveling direction of the vehicle), and decides recommended lanes for each block with reference to the second map information 62. The recommended lane decider 61 decides in which lane from the left the vehicle travels. When there is a branch on the route on the map, the recommended lane decider 61 decides a recommended lane so that the host vehicle M can travel along a reasonable route to proceed to a branch destination.

The second map information 62 is map information with higher accuracy than the first map information 54. The second map information 62 includes, for example, the number of lanes, types or shapes of road dividing lines (hereinafter referred to as dividing lines), information about centers of lanes, information about road boundaries, or the like. The second map information 62 may include information about whether or not the road boundaries are boundaries including a structure through which the vehicle cannot pass (including cross or contact). The structure may be, for example, a guardrail, a curb, a median strip, a fence, or the like. The concept “cannot pass” may include presence of a small step that can be passed if vibrations of a vehicle that may not normally occur are tolerated. The second map information 62 may include road shape information, traffic regulation information, address information (addresses and postal codes), facility information, parking information, telephone number information, or the like. The road shape information may be, for example, curvatures (which may be read as radii of curvature, and the same applies below) of roads, widths, gradients, or the like. The second map information 62 may be updated (renewed) at any time by the communication device 20 communicating with an external device. The first map information 54 and the second map information 62 may be provided as an integrated piece of map information. The map information may be stored in a storage 190.

The driving operator 80 includes, for example, a steering wheel, an accelerator pedal, and a brake pedal. The driving operator 80 may also include a shift lever, a special steering wheel, a joystick, or other operators. For example, an operation detector that detects an amount of an operation of an operator performed by the occupant or the presence or absence of an operation is attached to each operator of the driving operator 80. The operation detector detects, for example, a steering angle and a steering torque of the steering wheel, an amount of depression of the accelerator pedal or the brake pedal, or the like. In addition, the operation detector outputs detection results to the automated driving control device 100, or one of the driving force output device 200, the brake device 210, and the steering device 220, or both thereof.

The automated driving control device 100 executes various types of driving control relating to automated driving for the host vehicle M. The automated driving control device 100 includes, for example, a first controller 120, a second controller 160, an HMI controller 180, and the storage 190. The first controller 120, the second controller 160, and the HMI controller 180 are each realized by, for example, a hardware processor such as a central processing unit (CPU) executing a program (software). Some or all of these constituent elements may be realized by hardware (including circuitry) such as a large scale integration (LSI), an application specific integrated circuit (ASIC), a field-programmable gate array (FPGA), a graphics processing unit (GPU), or a system on chip (SOC), or may be realized by software in cooperation with hardware. The above-described program may be stored in advance in a storage device (a storage device including a non-transitory storage medium) such as an HDD, a flash memory, or the like of the automated driving control device 100, or may be stored in a removable storage medium such as a DVD, a CD-ROM, or a memory card and installed in a storage device of the automated driving control device 100 by inserting the storage medium (non-transitory storage medium) into a drive device, a card slot, or the like.

The storage 190 may be realized by the above-described various storage devices, or an electrically erasable programmable read only memory (EEPROM), a read only memory (ROM), or a random access memory (RAM), or the like. The storage 190 stores, for example, various types of information, programs, or the like according to the embodiment. The storage 190 may store the map information (for example, the first map information 54 and the second map information 62).

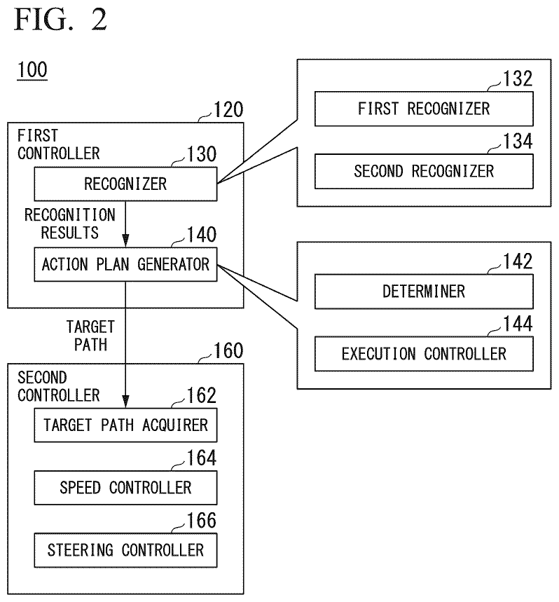

FIG. 2 is a functional configuration diagram of the first controller 120 and the second controller 160. The first controller 120 includes, for example, a recognizer 130 and an action plan generator 140. The first controller 120 realizes, for example, a function based on artificial intelligence (AI) and a function based on a pre-given model in parallel. For example, the function of “recognizing an intersection” may be realized by executing in parallel recognition of an intersection by deep learning or the like and recognition based on pre-given conditions (signals, road markings, or the like that can be pattern matched), and scoring and evaluating both of them comprehensively. This ensures reliability of the automated driving. The first controller 120 executes control relating to the automated driving of the host vehicle M on the basis of, for example, instructions from the MPU 60, the HMI controller 180, or the like.

The recognizer 130 recognizes surrounding conditions of the host vehicle M on the basis of recognition results of the detection device DD (information input from the camera 10, the radar device 12, and the LIDAR 14 via the object recognition device 16). For example, the recognizer 130 recognizes a state of the object present around (within a predetermined distance from) the host vehicle M, such as a position, a speed, an acceleration, or the like of the object. Examples of the object include, for example, other vehicles (surrounding vehicles), traffic participants (pedestrians, bicycles, or the like) traveling on the road, road structures, and other objects such as obstacles present in the vicinity. The road structures include, for example, road signs, traffic signals, railroad crossings, curbs, medians, guardrails, fences, or the like. The position of the object is recognized as a position on absolute coordinates with a representative point (a center of gravity, a center of a drive shaft, or the like) of the host vehicle M as the origin, and is used for control. The position of the object may be represented by a representative point such as a center of gravity or a corner of the object, or may be represented by a represented region. If the object is a mobile object such as another vehicle, the “state” of the object may include, for example, an acceleration, a jerk, or a “behavior state” (for example, whether another vehicle is changing lanes or is about to change lanes) of the mobile object.

The recognizer 130 includes, for example, a first recognizer 132 and a second recognizer 134. Details of these functions will be described later.

The action plan generator 140 generates an action plan for driving the host vehicle M by automated driving on the basis of the recognition results of the recognizer 130, or the like. For example, the action plan generator 140 generates a target path along which the host vehicle M will automatically (without depending on a driver's operation) travel in the future so that the host vehicle M travels in principle along the recommended lanes decided by the recommended lane decider 61 and can cope with the surrounding conditions of the host vehicle M on the basis of the recognition results by the recognizer 130 and the surrounding road shapes based on the current position of the host vehicle M acquired from the map information. The target path includes, for example, a speed element. For example, the target path is expressed as a path along which points (path points) to be reached by the host vehicle M are arranged in order. The path points are points at which the host vehicle M should arrive at each predetermined travel distance (for example, about a few meters) along the road, and separately, target speeds and target accelerations are generated as part of the target path for each predetermined sampling time (for example, about a few decimal second). The path points may be positions at which the host vehicle M should arrive at each predetermined sampling time. In this case, information about the target speeds and the target accelerations is expressed as intervals between the path points.

The action plan generator 140 may set automated driving events when the target path is generated. Examples of the events include, for example, a constant speed traveling event in which the host vehicle M is caused to travel in the same lane at a constant speed, a following traveling event in which the host vehicle M follows another vehicle that is within a predetermined distance (for example, within 100 [m]) in front of the host vehicle M and is closest to the host vehicle M, a lane change event in which the host vehicle M is caused to change lanes from the host vehicle's own lane to an adjacent lane, a branching event in which the host vehicle M is caused to branch into a destination side lane at a road branch point, a joint event in which the host vehicle M is caused to join a main lane at a joint point, a takeover event for terminating the automated driving and switching to manual driving, and the like. Examples of the events may include, for example, an overtaking event in which the host vehicle M is first caused to change lanes to an adjacent lane, to overtake a forward vehicle along the adjacent lane, and then to change lanes back to the original lane, an avoidance event in which the host vehicle M is caused to perform at least one of braking and steering to avoid an obstacle present in front of the host vehicle M, and the like.

The action plan generator 140 may change an event already decided for a current section to another event or set a new event for the current section in accordance with the surrounding conditions of the host vehicle M recognized during traveling of the host vehicle M. The action plan generator 140 may change an event already set for the current section to another event or set a new event for the current section in accordance with an operation of the occupant performed on the HMI 30. The action plan generator 140 generates the target path in accordance with to the set event.

The action plan generator 140 includes, for example, a determiner 142 and an execution controller 144. Details of these functions will be described later. For example, the recognizer 130 and the determiner 142 are examples of a “determination device.” The execution controller 144 and the second controller 160 are examples of a “driving controller.”

The second controller 160 controls the driving force output device 200, the brake device 210, and the steering device 220 so that the host vehicle M passes the target path generated by the action plan generator 140 at a scheduled time.

The second controller 160 includes, for example, a target path acquirer 162, a speed controller 164, and a steering controller 166. The target path acquirer 162 acquires information about the target path (path points) generated by the action plan generator 140 and stores it in a memory (not shown). The speed controller 164 controls the driving force output device 200 or the brake device 210 on the basis of speed elements associated with the target path stored in the memory. The steering controller 166 controls the steering device 220 in accordance with a curved state of the target path stored in the memory. The processing of the speed controller 164 and the steering controller 166 is realized, for example, by a combination of feedforward control and feedback control. As an example, the steering controller 166 executes a combination of feedforward control in accordance with a curvature of the road ahead of the host vehicle M and feedback control based on discrepancy from the target path.

Returning to FIG. 1, the HMI controller 180 notifies the occupant of predetermined information via the HMI 30. The predetermined information includes, for example, information relating to traveling of the host vehicle M, such as information about a state of the host vehicle M and information about driving control. The information about the state of the host vehicle M includes, for example, a speed, an engine speed, a shift position, or the like of the host vehicle M. The information about the driving control includes, for example, information for executing inquiry of the presence or absence of execution of driving control by automated driving and of whether or not automated driving is to be started, information about a driving control state by automated driving, information about an automation level, information for prompting the occupant to drive when driving is switched from automated driving to manual driving, or the like. The predetermined information may include information unrelating to traveling of the host vehicle M, such as television programs, content (for example, movies) stored in a storage medium such as a DVD. The predetermined information may include, for example, information about a current position or a destination in automated driving, and a remaining amount of fuel in the host vehicle M. The HMI controller 180 may output the information received by the HMI 30 to the communication device 20, the navigation device 50, the first controller 120, or the like.

The HMI controller 180 may cause the HMI 30 to output inquiry information for the occupant, processing results by the first controller 120 and the second controller 160, or the like. The HMI controller 180 may transmit various information output by the HMI 30 to a terminal device used by the user of the host vehicle M via the communication device 20.

The driving force output device 200 outputs a driving force (torque) for traveling the vehicle to driving wheels. The driving force output device 200 includes, for example, a combination of an internal combustion engine, an electric motor, a transmission, and the like, and an electronic control unit (ECU) that controls these. The ECU controls the above configuration in accordance with information input from the second controller 160 or information input from the accelerator pedal of the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor in accordance with information input from the second controller 160 or information input from the brake pedal of the driving operator 80, so that a brake torque in accordance with a braking operation is output to each wheel. The brake device 210 may be provided with a backup mechanism that transmits a hydraulic pressure generated by operating the brake pedal to the cylinder via a master cylinder. The brake device 210 is not limited to the configuration described above, and may be an electronically controlled hydraulic brake device that controls an actuator in accordance with the information input from the second controller 160 to transmit the hydraulic pressure of the master cylinder to the cylinder.

The steering device 220 includes, for example, a steering ECU and an electric motor. For example, the electric motor applies a force to a rack and pinion mechanism to change a direction of a steering wheel. The steering ECU drives the electric motor to change the direction of the steering wheel in accordance with the information input from the second controller 160 or information input from the steering wheel of the driving operator 80.

### Recognizer and Action Plan Generator

Next, details of functions of the recognizer 130 (the first recognizer 132 and the second recognizer 134) and the action plan generator 140 (the determiner 142 and the execution controller 144) will be described. In the following, determination processing according to the embodiment and driving control (traveling control) based on the determination results will be mainly described, and the determination processing will be described in several scenes.

### First Scene

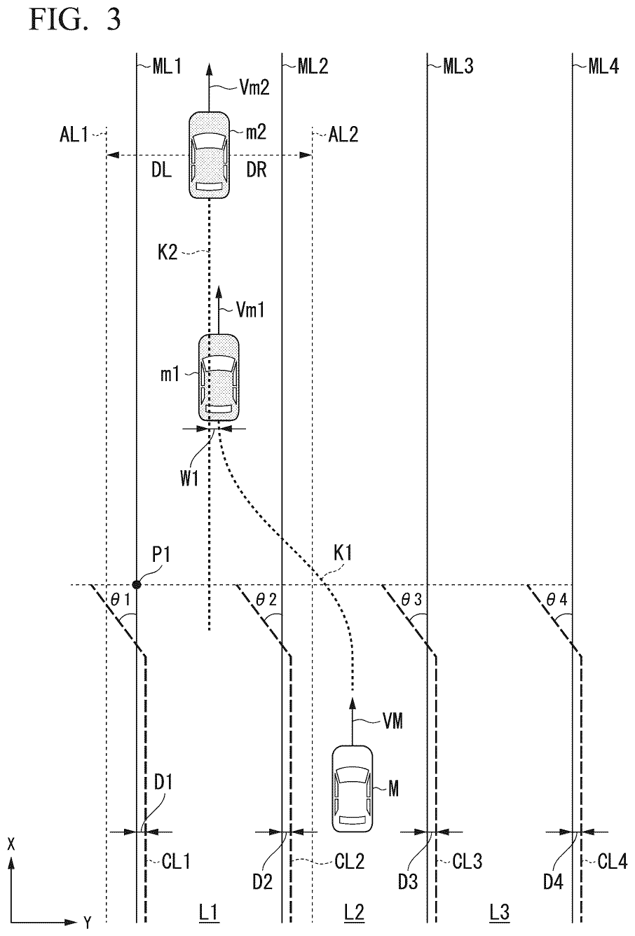

FIG. 3 is a diagram for illustrating the determination processing of the host vehicle M in a first scene. The example of FIG. 3 shows dividing lines CL1 to CL4 recognized by the detection device DD and dividing lines ML1 to ML4 obtained from the map information (for example, the second map information 62) on the basis of the position information of the host vehicle M. In the map information, a lane L1 is defined by the dividing lines ML1 and ML2, a lane L2 is defined by the dividing lines ML2 and ML3, and a lane L3 is defined by the dividing lines ML3 and ML4. The lanes L1 to L3 are lanes on which vehicles can travel in the same direction (the X axis direction in the figure). In the example of FIG. 3, the dividing lines CL1 to CL4 are examples of a “first dividing line,” and the dividing lines ML1 to ML4 are examples of a “second dividing line.” In FIG. 3, it is assumed that the host vehicle M travels on the lane L2 at a speed VM, another vehicle m1 (a forward vehicle) present in front of the host vehicle M travels at a speed Vm1, and another vehicle m2 (a further forward vehicle) present ahead of the other vehicle m1 travels on the lane L1 at a speed Vm2. A point P1 shown in FIG. 3 is a point at which, due to weather or other reasons, recognition accuracy falls below a threshold or the camera dividing lines CL1 to CL4 cannot be recognized (in other words, a recognizable range of the camera dividing lines). The other vehicle m1 shown in FIG. 3 is an example of a “first other vehicle,” and the other vehicle m2 is an example of a “second other vehicle.”

The first recognizer 132 recognizes the surrounding conditions of the host vehicle M on the basis of the output of the detection device DD that detects the surrounding conditions of the host vehicle. For example, the first recognizer 132 recognizes the left and right dividing lines CL2 and CL3 that divide the traveling lane (lane L2) of the host vehicle M on the basis of an image captured by the camera 10 (hereinafter, a camera image). The first recognizer 132 recognizes the dividing lines CL1 and CL2 that divide the adjacent lane L1 adjacent to the traveling lane, and the dividing lines CL3 and CL4 that divide the adjacent lane L3. Hereinafter, the dividing lines CL1 to CL4 may be referred to as “camera dividing lines CL1 to CL4.” For example, the first recognizer 132 analyzes the camera image, extracts edge points in the image that have large brightness differences from adjacent pixels, and connects the edge points, thereby recognizing each of the camera dividing lines CL1 to CL4 in the image plane. The first recognizer 132 converts positions of the camera dividing lines CL1 to CL4 based on a position of the representative point of the host vehicle M serving as a reference into a vehicle coordinate system (for example, the XY plane coordinates in FIG. 3). The first recognizer 132 may recognize, for example, curvatures of the camera dividing lines CL1 to CL4. The first recognizer 132 may recognize a curvature or an amount of curvature change of each of the camera dividing lines CL1 to CL4. The amount of curvature change is, for example, a change rate over time of the curvature of each of the camera dividing lines CL1 to CL4 recognized by the camera 10 at a distance x [m] forward when viewed from the host vehicle M. The first recognizer 132 may recognize the curvature or the amount of curvature change of the lane defined by the camera dividing lines CL1 to CL4 by averaging the curvature or the amount of curvature change of each of the camera dividing lines CL1 to CL4. The camera dividing lines CL1 to CL4 may be recognized or corrected on the basis of an output of a detection device other than the camera 10.

The first recognizer 132 recognizes other vehicles present around (within a predetermined distance from) the host vehicle M. In the example of FIG. 3, the first recognizer 132 recognizes the other vehicle m1 traveling ahead of the host vehicle M and the other vehicle m2 traveling further ahead of the other vehicle m1 when viewed from the host vehicle M on the basis of the output of the detection device DD that detects the surrounding conditions of the host vehicle M. The first recognizer 132 recognizes positions (relative positions with respect to the host vehicle M) and speeds (relative speeds with respect to the host vehicle M) of the other vehicles m1 and m2, and recognizes the traveling lanes of the other vehicles m1 and m2. The first recognizer 132 may recognize traveling position information of the other vehicles m1 and m2. The traveling position information is, for example, traveling paths K1 and K2 based on positions of representative points of the traveling other vehicles m1 and m2 at a predetermined time.

For example, the second recognizer 134 recognizes dividing lines of lanes around (within a predetermined distance from) the host vehicle M from the map information on the basis of the position of the host vehicle M detected by the vehicle sensor 40 or the GNSS receiver 51. In the example of FIG. 3, the second recognizer 134 refers to the map information on the basis of the position information of the host vehicle M and recognizes the dividing lines ML1 to ML4 present in the direction in which the host vehicle M is traveling or in which the host vehicle M can travel. Hereinafter, the dividing lines ML1 to ML4 may be referred to as “map dividing lines ML1 to ML4.”

The second recognizer 134 may recognize, among the recognized map dividing lines ML1 to ML4, the map dividing lines ML2 and ML3 as dividing lines that define the lane L2 on which the host vehicle M travels. The second recognizer 134 recognizes the curvature or the amount of curvature change of each of the map dividing lines ML1 to ML4 from the second map information 62. The second recognizer 134 may average the curvature or the amount of curvature change of each of the map dividing lines ML1 to ML4 and recognize the curvature or the amount of curvature change of each of the lanes L1 to L3 that are defined by the map dividing lines.

For example, the determiner 142 performs a correctness determination as to whether or not at least one of the camera dividing lines and the map dividing lines is correct on the basis of at least one of the camera dividing lines and the map dividing lines and the traveling paths of the other vehicles m1 and m2. On the basis of the determination results by the determiner 142, the execution controller 144 generates the target path for the driving control so that the host vehicle M travels along the dividing lines determined to be correct, or performs control to end (or not start) the driving control if both dividing lines are determined to be incorrect.

In the correctness determination, the determiner 142 first determines whether or not the camera dividing lines CL1 to CL4 recognized by the first recognizer 132 are discrepant from the map dividing lines ML1 to ML4 recognized by the second recognizer 134. For example, the determiner 142 derives a degree of discrepancy between the dividing lines CL2 and ML2 located closest to the left side of the host vehicle M, a degree of discrepancy between the dividing lines CL3 and ML3 located closest to the right side of the host vehicle M, and degrees of discrepancy between the dividing lines CL1 and ML1 and between the dividing lines CL4 and ML4 on adjacent lane sides. Then, the determiner 142 determines that the camera dividing lines and the map dividing lines are discrepant from each other when the derived degrees of discrepancy are equal to or greater than a threshold, and determines that they are not discrepant from each other when the derived degrees of discrepancy are less than the threshold. The above-described discrepancy determination is performed repeatedly at a predetermined timing or period.

For example, the determiner 142 superimposes the camera dividing lines CL1 to CL4 and the map dividing lines ML1 to ML4 on the plane of the vehicle coordinate system (XY plane) on the basis of the position of the representative point of the host vehicle M serving as the reference. Then, in the case of determining discrepancies of the dividing lines (the dividing lines CL1 and ML1, the dividing lines CL2 and ML2, the dividing lines CL3 and ML3, and the dividing lines CL4 and ML4) serving as comparison targets, the determiner 142 determines that the dividing lines are discrepant from each other if the degrees of discrepancy between the respective dividing lines are equal to or greater than the threshold, and determines that they are not discrepant from each other if the degrees of discrepancy are less than the threshold. The degree of discrepancy is, for example, a degree of discrepancy in a lateral position (for example, in the Y axis direction in the figure). In the example of FIG. 3, the discrepancy determination may be performed using an average value of an amount of deviation D1 between lateral positions of the dividing lines CL1 and ML1, an amount of deviation D2 between lateral positions of the dividing lines CL2 and ML2, an amount of deviation D3 between lateral positions of the dividing lines CL3 and ML3, and an amount of deviation D4 between lateral positions of the dividing lines CL4 and ML4, or the discrepancy determination may be performed using the maximum or minimum value of the amount of deviations D1 to D4.

The degree of discrepancy may be, for example, a degree (magnitude) of the angle formed by the two dividing lines serving as the comparison targets, instead of (or in addition to) the amount of deviation in the lateral position described above. In the example of FIG. 3, an average value of an angle θ1 formed by the dividing lines CL1 and ML1, an angle θ2 formed by the dividing lines CL2 and ML2, an angle θ3 formed by the dividing lines CL3 and ML3, and an angle 04 formed by the dividing lines CL4 and ML4 may be used, or the maximum or minimum value of the angles θ1 to θ4 may be used.

The degree of discrepancy may be, for example, a degree (magnitude) of a difference between the amounts of curvature change of the dividing lines, instead of (or in addition to) the amount of deviation in the lateral position or the angle formed by the dividing lines described above. The amount of curvature change is mainly used when the lane is a curved road. The determiner 142 may use an average value of a difference in curvature change between the dividing lines CL1 and ML1, a difference in curvature change between the dividing lines CL2 and ML2, a difference in curvature change between the dividing lines CL3 and ML3, and a difference in curvature change between the dividing lines CL4 and ML4, or may use the maximum or minimum value of the differences. The determiner 142 may use a difference between the average value of the curvature changes of the dividing lines CL1 to CL4 and the average value of the curvature changes of the dividing lines ML1 to ML4. Differences between the curvature changes of the lanes (lanes L1 to L3) recognized from the camera image and the curvature changes of the lanes recognized from the map information may be used.

For example, when the recognition accuracy of the camera dividing lines CL1 to CL4 recognized by the first recognizer 132 falls below a threshold or the camera dividing lines cannot be recognized, the determiner 142 may derive the degree of discrepancy using angles formed between the traveling paths K1 and K2 of the other vehicles traveling in the vicinity and the map dividing lines ML1 to ML4. The determiner 142 may set a virtual dividing line parallel to the traveling path K1 and determine the degree of discrepancy between the set virtual dividing line and the map dividing line. The determiner 142 may perform the discrepancy determination from the dividing lines using the traveling paths K1 and K2 regardless of the recognition results of the camera dividing lines CL1 to CL4.

When it is determined through the discrepancy determination using the degree of discrepancy described above that the camera dividing lines and the map dividing lines are not discrepant from each other, the determiner 142 determines that the camera dividing lines and the map dividing lines are correct dividing lines in the correctness determination. When it is determined that the camera dividing lines and the map dividing lines are discrepant from each other, the determiner 142 determines that at least one of the camera dividing lines and the map dividing lines is incorrect. For example, when the camera dividing lines and the map dividing lines are discrepant from each other and the host vehicle M is performing driving control to avoid an obstacle ahead, the determiner 142 determines that the camera dividing lines are incorrect (or the map dividing lines are correct). When the degree of discrepancy between the traveling path (or virtual dividing lines using the traveling path) of the forward vehicle traveling ahead of the host vehicle M and the map dividing lines are less than a threshold, the determiner 142 may determine that the map dividing lines are correct.

When the camera dividing lines and the map dividing lines are discrepant from each other and a predetermined number or more of the recognized plurality of traveling paths of the other vehicles are traveling paths that follow the camera dividing lines (including a predetermined tolerance range), the determiner 142 determines that the map dividing lines are incorrect (or the camera dividing lines are correct). When the first recognizer 132 recognizes information indicating a lane change (for example, an increase or decrease in lanes) such as a sign indicating road construction or a road sign indicating an increase or decrease in lanes, but there is no information indicating a lane change in road information acquired from the map information, the determiner 142 may determine that the map dividing lines are incorrect (or the camera dividing lines are correct) since it is old map information (or information that does not match the current road shape). For example, when the degree of discrepancy is equal to or greater than an upper limit value that is greater than a threshold, or when the number of dividing lines of the camera dividing lines differs from that of the map dividing lines, the determiner 142 may determine that the camera dividing lines and the map dividing lines are incorrect.

Here, in a situation in which the correctness determination of the dividing lines (or the discrepancy determination from the dividing lines) is performed using the traveling paths of the other vehicles, when the first recognizer 132 recognizes the plurality of other vehicles, if the first other vehicle that performs a lateral movement ahead of the host vehicle M and the second other vehicle that is present ahead of the first other vehicle and does not perform a lateral movement are present, the determiner 142 does not perform the correctness determination (discrepancy determination) based on the traveling path of the first other vehicle. The lateral movement is, for example, a movement of a predetermined distance or more in a road width direction of the map dividing lines (a movement in the Y axis direction in FIG. 3). The lateral movement may be a movement of a predetermined distance or more in a direction perpendicular to the traveling direction of the host vehicle M (in other words, in a vehicle width direction of the host vehicle M). The predetermined distance here may be, for example, a width of one lane, which corresponds to a lane change, or may be a variable distance in accordance with a road shape, or a fixed distance.

In the example of FIG. 3, the determiner 142 determines that the other vehicle m1 present forward from the host vehicle M is performing a lateral movement, and determines that the other vehicle m2 present forward from the other vehicle m1 is not performing a lateral movement, on the basis of the traveling paths K1 and K2 of the other vehicles m1 and m2 recognized by the first recognizer 132. Then, the determiner 142 does not perform the correctness determination based on the traveling path K1 of the other vehicle m1. In this case, the determiner 142 may perform the correctness determination using, for example, traveling paths of a plurality of other vehicles other than the other vehicle m1, and performs the correctness determination on the basis of traveling paths of some of the other vehicles excluding the first other vehicle. In the example of FIG. 3, the correctness determination is performed on the basis of the traveling path K2 of the other vehicle m2 other than the other vehicle m1.

For example, the determiner 142 determines that the dividing lines (at least one of the camera dividing lines CL or the map dividing lines ML) that follow the traveling path K2 of the other vehicle m2 are correct dividing lines. The dividing lines that follow the traveling path K2 are dividing lines that are determined not to be discrepant from the traveling path K2 through the discrepancy determination. The determiner 142 may determine that, among the camera dividing lines CL and the map dividing lines ML, the dividing lines whose discrepancy angles (the angles formed by the traveling direction of the other vehicle m2 and extension directions of the dividing lines) with respect to the traveling direction of the other vehicle m2 (or a longitudinal direction of a vehicle body of the other vehicle m2) are equal to or less than a threshold are correct dividing lines. Thus, the accuracy of the correctness determination of the dividing lines (determination of the road shape) using the other vehicles can be improved on the basis of the traveling path K2 of the other vehicle m2.

In the example of FIG. 3, the determiner 142 performs the discrepancy determination between the traveling path K2, the camera dividing lines CL, and the map dividing lines ML and the correctness determination based on the discrepancy determination results until the point P1 (the recognizable range of the camera dividing lines) that is a predetermined distance ahead from the current position of the host vehicle M. For sections farther from the host vehicle M than the point P1 (sections in which the traveling path K2 exists), the determiner 142 performs the discrepancy determination between the traveling path K2 and the map dividing lines ML and the correctness determination based on the discrepancy determination results.

The determiner 142 may perform the discrepancy determination and the correctness determination for the dividing lines included in a region of a predetermined width laterally in the vehicle width direction of the other vehicle m2 from the position at which the other vehicle m2 is present. In the example of FIG. 3, the determiner 142 sets a line AL1 that is a predetermined distance DL away from the other vehicle m2 in the vehicle width direction on the left side and extends in the longitudinal direction of the vehicle body, and a line AL2 that is a predetermined distance DR away from the other vehicle m2 in the vehicle width direction on the right side and extends in the longitudinal direction of the vehicle body. Then, the determiner 142 sets the camera dividing lines CL1 and CL2 and the map dividing lines ML1 and ML2 included in the region defined by the lines AL1 and AL2 as targets for the discrepancy determination and the correctness determination. For example, the predetermined distances DL and DR may be fixed distances such as one lane each (or one lane obtained by adding DL and DR), or may be variable distances depending on the road shape or a distance between the host vehicle M and the other vehicle m2. It is believed that a correct determination can be made at least the range within a predetermined region from the other vehicle m2, and thus by limiting the range, the accuracy of the correctness determination of the road shape (dividing lines) using the other vehicles can be improved.

For example, in a situation in which the other vehicle m2 that does not perform the lateral movement is present ahead of the other vehicle m1 that is performing the lateral movement when viewed from the host vehicle M, the lateral movement of the other vehicle m1, which is present ahead of the other vehicle m2 when viewed from the host vehicle M, is highly likely to be a lane change. Accordingly, by not making the correctness determination based on the traveling path K1 of the other vehicle m1 (or by not determining that the traveling path K1 is correct), the accuracy of the determination regarding the road shape can be improved. The road shape can be determined with high accuracy on the basis of the other vehicle m2.

The determiner 142 may add a further condition to a relationship between the other vehicle m1 (first other vehicle) and the other vehicle m2 (second other vehicle). For example, when the other vehicle m2 is at the same position as the lateral position (including a predetermined tolerance) of the other vehicle m1 reached as a result of the lateral movement and the other vehicle m2 is present in front of the other vehicle m1 without performing the lateral movement, the determiner 142 does not perform the correctness determination on the basis of the traveling path K1 of the other vehicle m1. In determining whether or not the other vehicle m2 is at the same position as the lateral position of the other vehicle m1 that has performed the lateral movement, for example, as shown in FIG. 3, an amount of deviation W1 in the lateral direction (Y axis direction in the figure) between the traveling paths K1 and K2 is compared, and if the amount of deviation W1 is less than a threshold, the other vehicle m2 is determined to be at the same position, and if the amount of deviation W1 is equal to or greater than the threshold, the other vehicle m2 is determined not to be at the same position.

### Second Scene

Instead of the above-described “as a result of the lateral movement of the other vehicle m1,” the determiner 142 may do so when the other vehicle m2 is at the same position as the lateral position at which the other vehicle ml was present “before the lateral movement.” The above content will be described below as a second scene, focusing on its differences from the first scene.

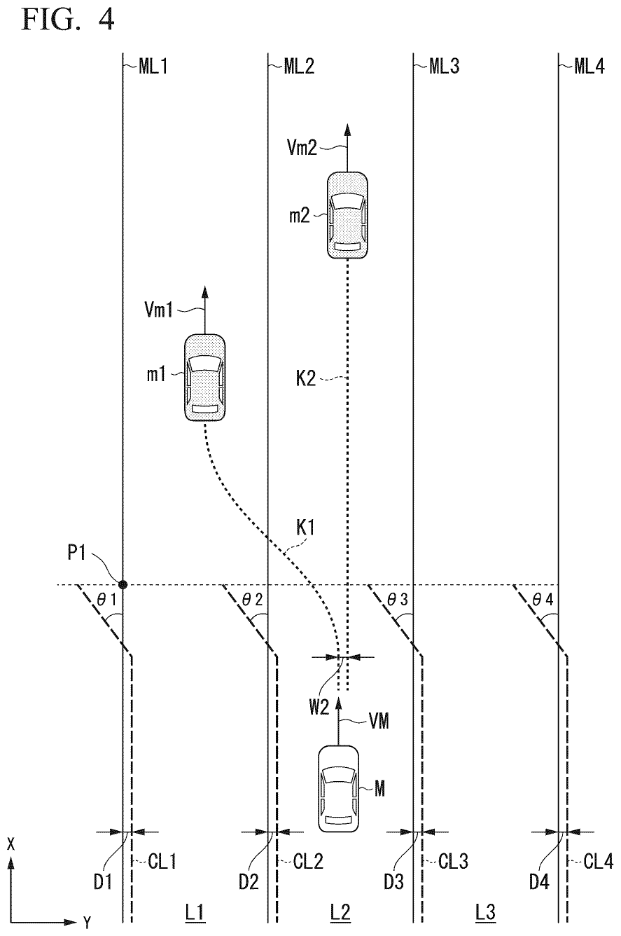

FIG. 4 is a diagram for illustrating the determination processing of the host vehicle M in the second scene. The example of FIG. 4 is different from the first scene shown in FIG. 3 in that the other vehicle m2 travels on the lane L2. In the second scene, when the other vehicle m2 is present in the same position as the lateral position at which the other vehicle m1 was present before it performed lateral movement and the other vehicle m2 is present in front of the other vehicle m1 (or the host vehicle M) without performing lateral movement, the determiner 142 does not perform the correctness determination based on the traveling path K1 of the other vehicle m1. In determining whether or not the other vehicle m2 is at the same position as the lateral position of the other vehicle m1 at which the other vehicle m1 was present before performing the lateral movement, for example, as shown in FIG. 4, an amount of deviation W2 in the lateral direction (Y axis direction in the figure) between the traveling paths K1 and K2 is compared, and if the amount of deviation W2 is less than a threshold, the other vehicle m2 is determined to be at the same position, and if the amount of deviation W2 is equal to or greater than the threshold, the other vehicle m2 is determined not to be at the same position.

In this way, by not making the correctness determination based on the traveling path of the other vehicle m1, which is estimated to be changing lanes to enter or exit the lane in which the other vehicle m2 was traveling, the accuracy of determining the road shape using the other vehicles can be further improved.

### Third Scene

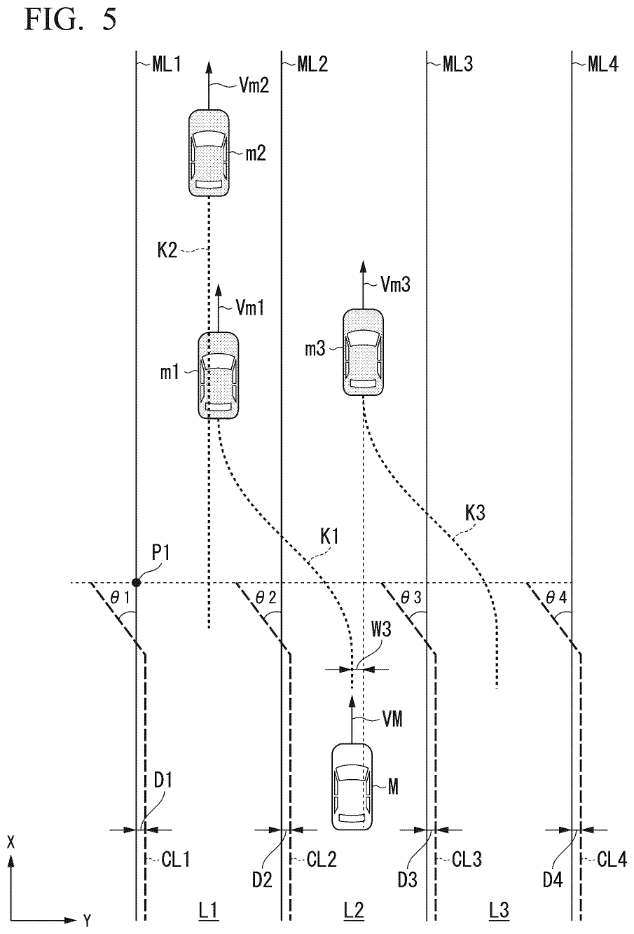

FIG. 5 is a diagram for illustrating the determination processing of the host vehicle M in a third scene. The example of FIG. 5 is different from the first scene shown in FIG. 3 in that, in addition to the other vehicles m1 and m2, another vehicle m3 is also present. The other vehicle m3 is a forward vehicle traveling ahead at a speed Vm3 when viewed from the host vehicle M. The other vehicle m3 is an example of a “third other vehicle.” The third other vehicle is, for example, another vehicle that is present behind the other vehicle m2, is present in the lateral direction of the other vehicle m1 (in the lateral direction of the other vehicle m1 and within a predetermined distance in the longitudinal direction), and performs a lateral movement (a vehicle traveling parallel to the other vehicle m1).

In the third scene, the first recognizer 132 recognizes, in addition to the other vehicles m1 and m2, a position (a relative position with respect to the host vehicle M), a speed (a relative speed with respect to the host vehicle M), a traveling lane, and traveling position information (for example, a traveling path K3) of the other vehicle m3. On the basis of the recognition results, for example, as shown in FIG. 5, when the other vehicle m3 is present behind the other vehicle m2 besides the other vehicle m1 and a lateral position of the other vehicle m3 reached as a result of the lateral movement or a lateral position thereof after the lateral movement is different from the lateral position of the second vehicle m2, the determiner 142 does not perform the correctness determination based on the traveling paths K1 and K3 of the other vehicles m1 and m3.

Instead of (or in addition to) “when the lateral position of the other vehicle m3 reached as a result of the lateral movement or the lateral position after the lateral movement is different from the lateral position of the other vehicle m2,” the determiner 142 may do so “when the lateral position at which the other vehicle m3 has arrived through the lateral movement is the same position as the lateral position of the other vehicle m1.” In determining whether or not they are the same position, for example, as shown in FIG. 5, an amount of deviation W3 in the lateral direction (Y axis direction in the figure) between the traveling path K1 before the other vehicle m1 performs the lateral movement and the traveling path K3 after the other vehicle m3 has performed the lateral movement is compared, and if the amount of deviation W3 is less than a threshold, the other vehicle m3 is determined to be present in the same position, and if it is equal to or greater than the threshold, the other vehicle m3 is determined not to be present in the same position. In the example of FIG. 5, the lateral position (coordinate on the Y axis) of the other vehicle m3 reached as a result of the lateral movement is determined to be different from the lateral position of the other vehicle m2 and the same position as the lateral position of the other vehicle ml before the lateral movement.

### Fourth Scene

Instead of the above-described “when the lateral position of the other vehicle m3 reached as a result of the lateral movement is the same position as the lateral position of the other vehicle m1,” the determiner 142 may do so “when the lateral position of the other vehicle m3 before the lateral movement is the same position as the lateral position of the other vehicle m1.” The above content will be described below as a fourth scene, focusing on its differences from the third scene.

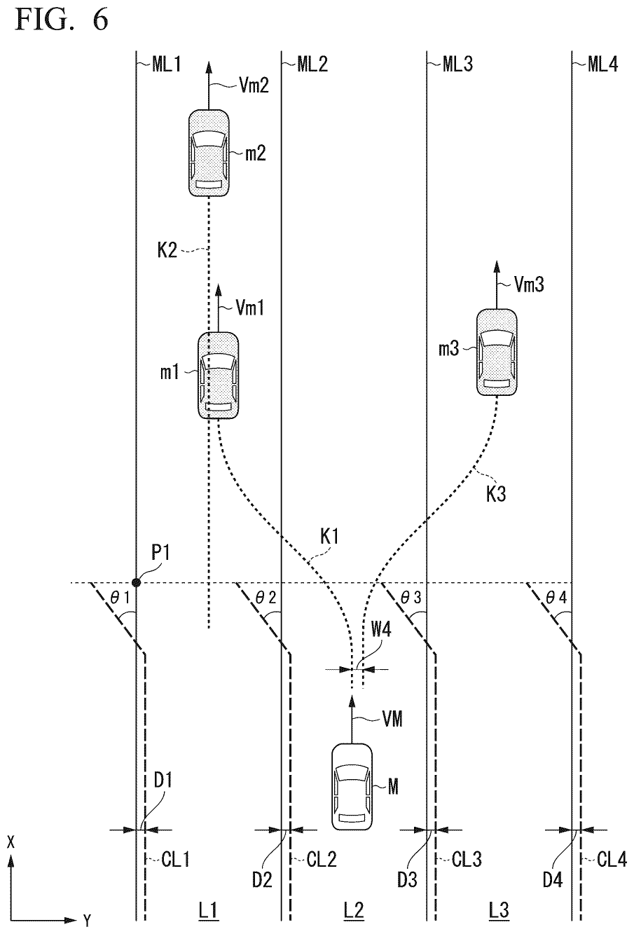

FIG. 6 is a diagram for illustrating the determination processing of the host vehicle M in the fourth scene. The example in FIG. 6 is different from the third scene shown in FIG. 5 in that the other vehicle m3 does not perform a lateral movement to the left (from the lane L3 to the lane L2) but to the right (from the lane L2 to the lane L3). In the third scene, the other vehicles m1 and m3 perform the lateral movements in the same direction, and in the fourth scene, the other vehicles m1 and m3 perform lateral movements in opposite directions.

In the fourth scene, when the other vehicle m3 is present behind the other vehicle m2 besides the other vehicle ml and the lateral position of the other vehicle m3 before the lateral movement is the same as the lateral position of the other vehicle m1, the determiner 142 does not perform the correctness determination based on the traveling paths K1 and K3 of the other vehicles m1 and m3. In determining whether or not they are the same position, for example, as shown in FIG. 6, an amount of deviation W4 in the lateral direction (Y axis direction in the figure) between the traveling path K1 of the other vehicle m1 before the lateral movement and the traveling path K3 of the other vehicle m3 before the lateral movement is compared, and if the amount of deviation W4 is less than a threshold, they are determined to be at the same position, and if it is equal to or greater than the threshold, they are determined not to be at the same position. In the example of FIG. 6, the lateral position (coordinate on the Y axis) of the other vehicle m3 before the lateral movement is determined to be different from the lateral position of the other vehicle m2 and the same position as the lateral position of the other vehicle m1 before the lateral movement.

For example, the determiner 142 may include in the conditions that the third other vehicle is a vehicle that performs the lateral movement in the same direction as the first other vehicle (the other vehicle m1). In this case, in the third scene shown in FIG. 5, the lateral movement directions of the other vehicles m1 and m3 are the same (leftward), and thus the determiner 142 does not perform the correctness determination of the dividing lines based on the traveling paths K1 and K3. In excluding the traveling path K1 of the other vehicle m1 from the determination, by also excluding the other vehicle m3 that has performed the lateral movement in the same direction, the determination accuracy can be improved. In the fourth scene shown in FIG. 6, the other vehicle m3 does not perform the correctness determination either, but the lateral movement directions of the other vehicles m1 and m3 are opposite, and thus the determiner 142 may perform the correctness determination of the dividing lines based on at least the traveling path K3, without performing exclusion based on the other vehicle m2 from the fact that neither the lateral position reached as a result of the lateral movement or the lateral position before the lateral movement is the same as that of the other vehicle m2.

In this way, even when the plurality of other vehicles that perform the lateral movements are present, the dividing lines used for the correctness determination (or discrepancy determination) can be more appropriately selected on the basis of the traveling paths of and the positional relationship between the forward vehicle and the more forward vehicle. Accordingly, the correctness determination of the dividing lines can be more appropriately performed, and the determination accuracy of the road shape can be improved. The dividing lines used for the correctness determination (or discrepancy determination) can be more appropriately selected on the basis of the positional relationship (lateral positional relationship before or after the lateral movement) between the other vehicle m1 (first other vehicle) and the other vehicle m3 (third other vehicle), and the determination accuracy can be further improved.

Instead of determining whether or not the forward vehicle (the first other vehicle or the third other vehicle) is performing the lateral movement, the determiner 142 may determine whether or not at least a part of the forward vehicle has traveled across the map dividing lines. In this case, when at least a part of the forward vehicle is traveling across the map dividing lines and the more forward vehicle (second other vehicle) is traveling along the map dividing lines, the determiner 142 determines that the map dividing lines are correct.

In the above-described first to fourth scenes, if only a part of the traveling path of the more forward vehicle (the other vehicle m2) could be acquired for some reason, the determiner 142 may perform the correctness determination of the dividing lines on the basis of the traveling path of the other vehicle m2 and the traveling path of the other vehicle m1 (including the other vehicle m3 in the third and fourth scenes). “Some reason” may be, for example, a reason that the more forward vehicle (the other vehicle m2) could not be recognized (hidden) from the position of the host vehicle M due to the influence of the forward vehicle (for example, the other vehicle m1) or other obstacles, but is not limited to this reason. A part of the traveling path of the more forward vehicle may be, for example, a traveling path farther away from the point at which the lateral movement of the other vehicle m1 is completed when viewed from the host vehicle M, or may be a traveling path less than a processing distance. In this way, when only a part of the traveling path of the more forward vehicle can be acquired, by performing the correctness determination of the dividing line including the traveling path of the forward vehicle, more appropriate determination processing can be performed depending on the situation.

The execution controller 144 decides the driving control for the host vehicle M on the basis of the determination results by the determiner 142 and executes the decided driving control. “Deciding the driving control” may include, for example, deciding the content (type) of the driving control, or deciding whether or not to execute (inhibit) the driving control. “Executing the driving control” may include, for example, continuing the driving control that is already being executed, in addition to switching and executing the content of the driving control. Inhibiting the driving control may include not only not executing (terminating) the driving control, but also lowering an automation level of the driving control. The driving control executed by the execution controller 144 may include ACC, TJP, LKAS, ALC, CMBS, or the like, and may also include various types of driving control for avoiding contact with surrounding vehicles. The execution controller 144 generates the target path for executing the driving control and outputs the generated target path to the second controller 160.

Here, in the first scene, the driving control executed by the execution controller 144 includes at least first driving control and second driving control. The first driving control is, for example, driving control that executes at least steering control of steering or a speed of the host vehicle M on the basis of the dividing line (for example, the dividing line at a portion at which the camera dividing line is not discrepant from the map dividing line) recognized by the first recognizer 132 or the second recognizer 134.

For example, the first driving control is driving control that drives the host vehicle M so that the representative point of the host vehicle M passes through a center of a lane defined by dividing lines. The second driving control is, for example, driving control that executes at least steering control of steering or a speed of the host vehicle M on the basis of the map dividing lines and the traveling position information of the other vehicles. The second driving control is, for example, driving control that drives the host vehicle M so that the representative point of the host vehicle M travels on a path along the traveling path of the other vehicle m1.

Further, the driving control may include third driving control that executes at least steering control of steering or a speed of the host vehicle M by prioritizing the camera dividing lines over the map dividing lines, or fourth driving control that executes at least steering control of steering or a speed of the host vehicle M by prioritizing the map dividing lines over the camera dividing lines. Prioritizing the camera dividing lines over the map dividing lines indicates, for example, that processing based on the camera dividing lines is basically performed, but temporarily switches to processing based on the map dividing lines when, for example, the recognition accuracy of the camera dividing lines becomes lower than a threshold or they cannot be recognized. Prioritizing the map dividing lines over the camera dividing lines indicates that processing based on the map dividing lines is basically performed, but temporarily switches to processing based on the camera dividing lines when, for example, the map dividing lines cannot be identified. The third driving control and the fourth driving control are driving control when, for example, the camera dividing lines are discrepant from the map dividing lines.

The driving control may include a plurality of types of driving control based on an automation level (an example of a degree of automation). The automation level may include, for example, a first level, a second level having a lower degree of automation of driving control than the first level, and a third level having a lower degree of automation of driving control than the second level. The automation level may include a fourth level (an example of a fourth degree of control) having a lower degree of automation of driving control than the third level. Here, the automation level may be a level determined by standardized information, laws and regulations, or the like, or may be an index value set regardless of these. Accordingly, types, contents, and the number of automation levels are not limited to the following examples. A low degree of automation of driving control indicates, for example, that an automation rate in driving control is low and tasks assigned to the driver are large (severe). A low automation of driving control indicates that a degree to which the automated driving control device 100 controls steering, acceleration, or deceleration of the host vehicle M is low (a degree to which the driver needs to intervene an operation of steering, acceleration, or deceleration is high). The tasks assigned to the driver include, for example, monitoring surroundings of the host vehicle M, operating the driving operator, or the like. Operating the driving operator includes, for example, a state in which the driver holds the steering wheel (hereinafter, referred to as a hands-on state). The tasks assigned to the driver include, for example, a task for the occupant (a driver task) required to maintain the automated driving of the host vehicle M. Accordingly, if the occupant cannot perform the assigned task, the automation level will be reduced. For example, the driving control at the first level may include, for example, driving control such as ACC, ALC, LKAS, or TJP. The driving control at the second or third level may include, for example, driving control such as ACC, ALC, or LKAS. The driving control at the fourth level may include manual driving. In the driving control at the fourth level, for example, driving control such as ACC may be executed. Among the first to fourth levels, the first level has the highest degree of automation of driving control, and the fourth level has the lowest degree of automation of driving control.

No task is assigned to the occupant at the first level (the task assigned to the driver is the lightest). The task assigned to the occupant at the second level is, for example, monitoring the surroundings (particularly the front) of the host vehicle M. The task assigned to the occupant at the third level includes, for example, the hands-on state in addition to monitoring the surroundings of the host vehicle M. The task assigned to the occupant (for example, the driver) at the fourth level is, for example, an operation to control the steering and the speed of the host vehicle M using the driving operator 80 in addition to monitoring the surroundings of the host vehicle M and being in the hands-on state. That is, in the case of the fourth level, the occupant can immediately take over driving, and the task assigned to the driver is the most severe. The content of driving control and the tasks assigned to the occupant at each automation level are not limited to the above-described examples. The automated driving control device 100 executes driving control at any one of the first to fourth levels on the basis of the surrounding conditions of the host vehicle M and the task being performed by the occupant. At least some of the first to fourth levels may be associated with the first driving control to the fourth driving control described above, for example.

For example, when the determiner 142 determines that both the camera dividing lines CL and the map dividing lines ML are correct dividing lines (for example, the camera dividing lines CL and the map dividing lines ML are not discrepant from each other), the execution controller 144 generates a target path for executing the first driving control. When one of the camera dividing lines CL and the map dividing lines ML is determined to be correct, a target path for executing one of the second driving control to the fourth driving control is generated on the basis of the correct dividing lines. The execution controller 144 may perform control such as terminating the driving control of the host vehicle M and switching to manual driving by the occupant on the basis of the determination results. Further, the execution controller 144 may switch the automation level corresponding to the driving control on the basis of the determination results. In this case, for example, if the camera dividing lines CL and the map dividing lines ML are determined to be correct, the driving control at the first level is executed, and if they are determined to be incorrect, the driving control at the second to fourth levels is executed depending on the situation.

### Processing Flow

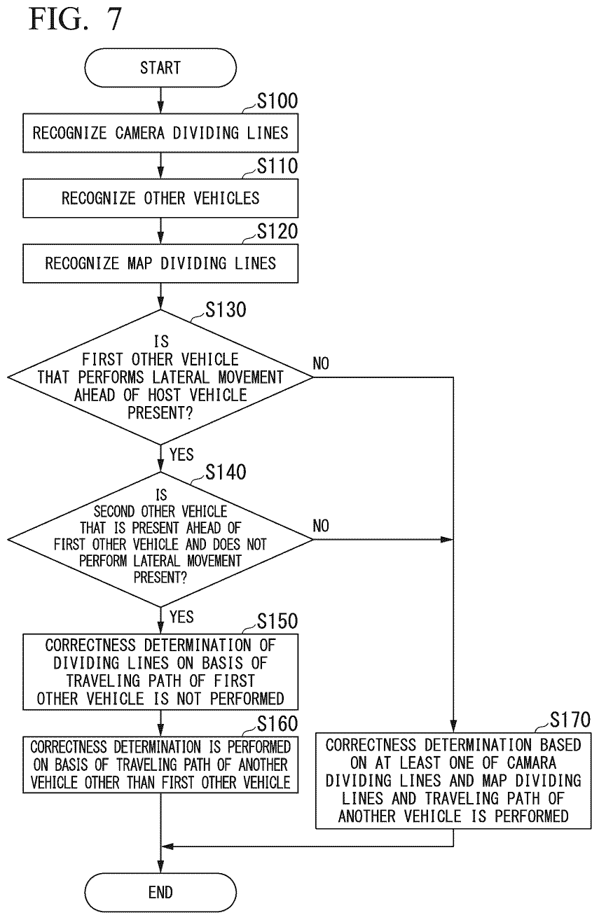

The processing executed by the automated driving control device 100 of the embodiment will be described below. FIG. 7 is a flowchart showing an example of the processing executed by the automated driving control device 100 of the embodiment. In the following, among the processes executed by the automated driving control device 100, the correctness determination processing of at least one of the camera dividing lines CL and the map dividing lines ML will be mainly described. The automated driving control device 100 executes the driving control of the host vehicle M in accordance with the results of the determination processing shown in FIG. 7. The processing shown below may be executed repeatedly at a predetermined timing or at a predetermined cycle, and may be executed repeatedly while the automated driving by the automated driving control device 100 is being executed.

In the example of FIG. 7, the first recognizer 132 recognizes the dividing lines (camera dividing lines CL) present around the host vehicle M on the basis of an output of the detection device DD that has detected the surrounding conditions of the host vehicle M (step S100). Next, the first recognizer 132 recognizes other vehicles present around the host vehicle M (step S110). In the processing of step S110, for example, positions, speeds, traveling lanes, and traveling position information (traveling paths) of the other vehicles are recognized. Next, the second recognizer 134 refers to the map information on the basis of the position information of the host vehicle M, and recognizes the dividing lines (map dividing lines ML) present around the host vehicle M from the map information (step S120).

Next, the determiner 142 determines whether or not the first other vehicle that performs the lateral movement ahead of the host vehicle M is present (step S130). If the first other vehicle is determined to be present, the determiner 142 determines whether or not the second other vehicle that is present ahead of the first other vehicle and does not perform the lateral movement is present (step S140). If the second other vehicle is determined to be present, the determiner 142 does not perform the correctness determination as to whether or not at least one of the camera dividing lines and the map dividing lines is correct on the basis of the traveling path of the first other vehicle (step S150). In this case, the determiner 142 performs the correctness determination on the basis of traveling paths of other vehicles other than the first other vehicle recognized by the first recognizer 132 (step S160).

If it is determined in the processing of step S130 that the first other vehicle performing the lateral movement ahead of the host vehicle M is not present, or if it is determined in the processing of step S140 that the second other vehicle not performing the lateral movement ahead of the first other vehicle is not present, the determiner 142 performs the correctness determination based on at least one of the camera dividing lines and the map dividing lines, and the traveling paths of the other vehicles (step S170). This ends the processing of the present flowchart.

According to the above-described embodiment, the determination device (the recognizer 130 and the determiner 142) includes the first recognizer 132 that recognizes the surrounding conditions including the camera dividing lines (first dividing lines) that define the traveling lane of the host vehicle M and other vehicles present around the host vehicle M on the basis of the output of the detection device DD that detects the surrounding conditions of the host vehicle M, the second recognizer 134 that recognizes the camera dividing lines (second dividing lines) that define the lanes around the host vehicle M from the map information on the basis of the position information of the host vehicle M, and the determiner 142 that performs the correctness determination as to whether or not at least one of the camera dividing lines and the map dividing lines is correct on the basis of at least one of the camera dividing lines and the map dividing lines and the traveling paths of the other vehicles. When the first other vehicle that performs a lateral movement ahead of the host vehicle M and the second other vehicle that does not perform a lateral movement ahead of the first other vehicle are present among a plurality of other vehicles recognized by the first recognizer 132, the determiner 142 can determine the correctness of the dividing lines more appropriately in accordance with the conditions of the dividing lines around the host vehicle and the other vehicles by not performing the correctness determination based on the traveling path of the first other vehicle. On the basis of the determination results, more appropriate driving control can be executed, and the continuity of driving control can be further improved. This, in turn, can contribute to the development of a sustainable transportation system.

According to the embodiment, on the basis of the traveling path of the other vehicle traveling ahead of the host vehicle M, when the other vehicle is performing a lateral movement, the other vehicle is estimated to be changing lanes and not used for the correctness determination of the dividing lines, and thus the determination accuracy can be improved.

The embodiment described above can be expressed as follows.

A determination device including:
a storage medium configured to store computer-readable instructions; and
a processor connected to the storage medium,
the processor executing the computer-readable instructions to:
recognize surrounding conditions including a first dividing line defining a lane of a host vehicle and another vehicle present around the host vehicle on the basis of an output of a detection device configured to detect the surrounding conditions of the host vehicle;
recognize a second dividing line defining a lane around the host vehicle from map information on the basis of position information of the host vehicle;
perform a correctness determination as to whether or not at least one of the first dividing line and the second dividing line is correct on the basis of at least one of the first dividing line and the second dividing line and a traveling path of the other vehicle, and
when a first other vehicle that performs a lateral movement ahead of the host vehicle and a second other vehicle that does not perform a lateral movement ahead of the first other vehicle are present among a plurality of other vehicles recognized, the correctness determination based on a traveling path of the first other vehicle is not performed.

Although the aspects for carrying out the present invention has been described above using the embodiment, the present invention is not limited to such an embodiment, and various modifications and substitutions can be made without departing from the scope of the gist of the present invention.

What is claimed is:

1. A determination device comprising:
a first recognizer configured to recognize surrounding conditions including a first dividing line defining a traveling lane of a host vehicle and another vehicle present around the host vehicle on the basis of an output of a detection device configured to detect surrounding conditions of the host vehicle; a second recognizer configured to recognize a second dividing line defining a lane around the host vehicle from map information on the basis of position information of the host vehicle; and a determiner configured to perform a correctness determination as to whether or not at least one of the first dividing line and the second dividing line is correct on the basis of at least one of the first dividing line and the second dividing line and a traveling path of the other vehicle,
wherein when a first other vehicle that is performing a lateral movement ahead of the host vehicle and a second other vehicle that is not performing a lateral movement ahead of the first other vehicle are present among a plurality of other vehicles recognized by the first recognizer, the determiner does not perform the correctness determination based on a traveling path of the first other vehicle.

2. The determination device according to claim 1, wherein when the second other vehicle is at the same position as a lateral position of the first other vehicle reached as a result of the lateral movement or present there before the lateral movement and is ahead of the first other vehicle, the determiner does not perform the correctness determination based on the traveling path of the first other vehicle.

3. The determination device according to claim 1, wherein the determiner determines that, among the first dividing line and the second dividing line, a dividing line along a traveling path of the second other vehicle is a correct dividing line.

4. The determination device according to claim 1, wherein the determiner determines that, among the first dividing line and the second dividing line, a dividing line whose discrepancy angle with respect to a traveling direction of the second other vehicle is equal to or smaller than a threshold is a correct dividing line.

5. The determination device according to claim 2, wherein when a third other vehicle whose lateral position reached as a result of a lateral movement or a lateral position before the lateral movement is different from a lateral position of the second other vehicle is present behind the second other vehicle, the determiner does not perform the correctness determination based on the traveling path of the first other vehicle and a traveling path of the third other vehicle.

6. The determination device according to claim 5, wherein the third other vehicle is a vehicle whose lateral position reached as a result of the lateral movement or the lateral position before the lateral movement is at the lateral position of the first other vehicle before the lateral movement of the first other vehicle.

7. The determination device according to claim 5, wherein the third other vehicle is a vehicle that performs the lateral movement in the same direction as the first other vehicle.

8. The determination device according to claim 1, wherein the determiner performs the correctness determination in a region of a predetermined width in a vehicle width direction on the basis of a position at which the second other vehicle is present.

9. The determination device according to claim 1, wherein when only a traveling path in which the traveling path of the second other vehicle is farther away than a point at which the lateral movement of the first other vehicle that performs the lateral movement is completed ahead of the host vehicle is acquired, the determiner performs the correctness determination based on the traveling path of the first other vehicle and the traveling path of the second other vehicle.

10. A determination method configured to cause a computer to execute:
recognizing surrounding conditions including a first dividing line defining a traveling lane of a host vehicle and another vehicle present around the host vehicle on the basis of an output of a detection device configured to detect surrounding conditions of the host vehicle;
recognizing a second dividing line defining a lane around the host vehicle from map information on the basis of position information of the host vehicle; and
performing a correctness determination as to whether or not at least one of the first dividing line and the second dividing line is correct on the basis of at least one of the first dividing line and the second dividing line and a traveling path of the other vehicle,
wherein when a first other vehicle that performs a lateral movement ahead of the host vehicle and a second other vehicle that does not perform a lateral movement ahead of the first other vehicle are present among a plurality of other vehicles recognized, the correctness determination based on a traveling path of the first other vehicle is not performed.

11. A computer-readable non-transitory storage medium that stores a program configured to cause a computer to execute:
recognizing surrounding conditions including a first dividing line defining a traveling lane of a host vehicle and another vehicle present around the host vehicle on the basis of an output of a detection device configured to detect surrounding conditions of the host vehicle;
recognizing a second dividing line defining a lane around the host vehicle from map information on the basis of position information of the host vehicle; and
performing a correctness determination as to whether or not at least one of the first dividing line and the second dividing line is correct on the basis of at least one of the first dividing line and the second dividing line and a traveling path of the other vehicle,
wherein when a first other vehicle that performs a lateral movement ahead of the host vehicle and a second other vehicle that does not perform a lateral movement ahead of the first other vehicle are present among a plurality of other vehicles recognized, the correctness determination based on a traveling path of the first other vehicle is not performed.
